(19) United States
(12) Patent Application Publication
(10) Pub. No.: US 2026/0081550 A1
(43) Pub. Date: Mar. 19, 2026

(54) ELECTRIC POWER CONVERTER CONTROL DEVICE AND ELECTRIC POWER CONVERSION DEVICE

(71) Applicant: Hitachi Astemo, Ltd., Hitachinaka-shi, Ibaraki (JP)

(72) Inventor: Takami SUZUKI, Hitachinaka-shi (JP)

(21) Appl. No.: 19/110,002

(22) PCT Filed: Oct. 18, 2022
(86) PCT No.: PCT/JP2022/038700

§ 371 Date: Mar. 7, 2025

(51) Int. Cl. H02P 27/08; H02M 7/5395; H02P 21/00

(52) U.S. Cl. CPC H02P 27/08; H02M 7/5395; H02P 21/50

(57) ABSTRACT

An electric power converter control device controls an electric power converter that performs electric power conversion between a direct current electric power supply and a motor, the electric power converter control device including: a magnetic flux command value generator configured to obtain a magnetic flux command value based on a torque command value and a rotation detection value indicating the rotational speed of the motor; a direct current voltage value generator configured to obtain a direct current voltage value indicating an output voltage of the direct current electric power supply based on at least a modulation rate coefficient targeted by the electric power converter and the magnetic flux command value; and a current command value generator configured to obtain a current command value for controlling the motor based on the torque command value, the rotation detection value, and the direct current voltage value.

### TECHNICAL FIELD

The present invention relates to an electric power converter control device and an electric power conversion device.

### BACKGROUND ART

A motor control device is known, which performs vector control of an alternating current motor based on a d-axis and a q-axis. The motor control device that performs the vector control generates a d-axis current command value id* and a q-axis current command value iq*, and controls the drive of the alternating current motor based on the d-axis current command value id* and the q-axis current command value iq*. For example, Patent Document 1 discloses a motor control method for an electric vehicle of performing the vector control as described above. In the motor control method for an electric vehicle disclosed in Patent Document 1, a magnetic flux command value is generated from a torque command value, and further, a current command value is obtained based on a map showing a relationship between the torque command value, the magnetic flux command value, and the current command values (d-axis current command value id* and q-axis current command value iq*).

### CITATION LIST

### Patent Document

Patent Document 1: Japanese Patent No. 6192263

### SUMMARY OF INVENTION

### Technical Problem

However, in a motor actually mounted in a vehicle, a maximum torqe per ampere (MTPA) line may change or a center point of a magnetic flux restriction circle may change in accordance with a change in the rotational speed of the motor or a change in an output voltage of a direct current electric power supply. That is, in the motor actually mounted in the vehicle, the response characteristics with respect to the torque command value change due to both the rotational speed and the output voltage of the direct current electric power supply. Therefore, in a case in which the current command value is obtained from a single map based on the torque command value and the magnetic flux command value as in Patent Document 1, the difference between the torque command value and the output torque may be large. Therefore, in the motor control method for an electric vehicle disclosed in Patent Document 1, it may be difficult to ensure the accuracy of the output torque with respect to the torque command value.

The present invention has been made in view of the above-described problems, and an object of the present invention is to improve accuracy of output torque with respect to a torque command value in a case of controlling a motor.

### Solution to Problem

The present invention employs the following configurations as means for solving the above-described object.

A first aspect of the present invention employs a configuration of an electric power converter control device that controls an electric power converter that performs electric power conversion between a direct current electric power supply and a motor, the electric power converter control device including: a magnetic flux command value generator configured to obtain a magnetic flux command value based on a torque command value and a rotation detection value indicating the rotational speed of the motor; a direct current voltage value generator configured to obtain a direct current voltage value indicating an output voltage of the direct current electric power supply based on at least a modulation rate coefficient targeted by the electric power converter and the magnetic flux command value; and a current command value generator configured to obtain a current command value for controlling the motor based on the torque command value, the rotation detection value, and the direct current voltage value.

### Advantageous Effects of Invention

In the present invention, the current command value is obtained based on the rotation detection value indicating the rotational speed of the motor and the direct current voltage value indicating the output voltage of the direct current electric power supply. Therefore, in the present invention, it is possible to obtain the current command value in accordance with both the rotation detection value and the direct current voltage value. Therefore, in the present invention, even in a case in which the rotational speed of the motor and the direct current voltage value are changed, the difference between the torque command value and the output torque can be reduced, and the accuracy of the output torque with respect to the torque command value can be improved.

### BRIEF DESCRIPTION OF DRAWINGS

FIG. 1 A circuit diagram schematically showing the schematic configuration of a motor control device according to the present embodiment.

FIG. 2 A block diagram showing the functional configuration of an electric power converter control device according to the present embodiment.

FIG. 3 A block diagram showing the functional configuration of a torque controller according to the present embodiment.

FIG. 4 A block diagram showing the functional configuration of a magnetic flux command value generator according to the present embodiment.

FIG. 5 A conceptual diagram of a current command value map according to the present embodiment.

FIG. 6 A schematic diagram showing the operations and effects of the electric power converter control device according to the present embodiment.

FIG. 7 A schematic diagram showing the operations and effects of the electric power converter control device according to the present embodiment.

FIG. 8 A schematic diagram showing the operations and effects of the electric power converter control device according to the present embodiment.

### DESCRIPTION OF EMBODIMENTS

Hereinafter, embodiments of an electric power converter control device and an electric power conversion device according to the present invention will be described with reference to the drawings.

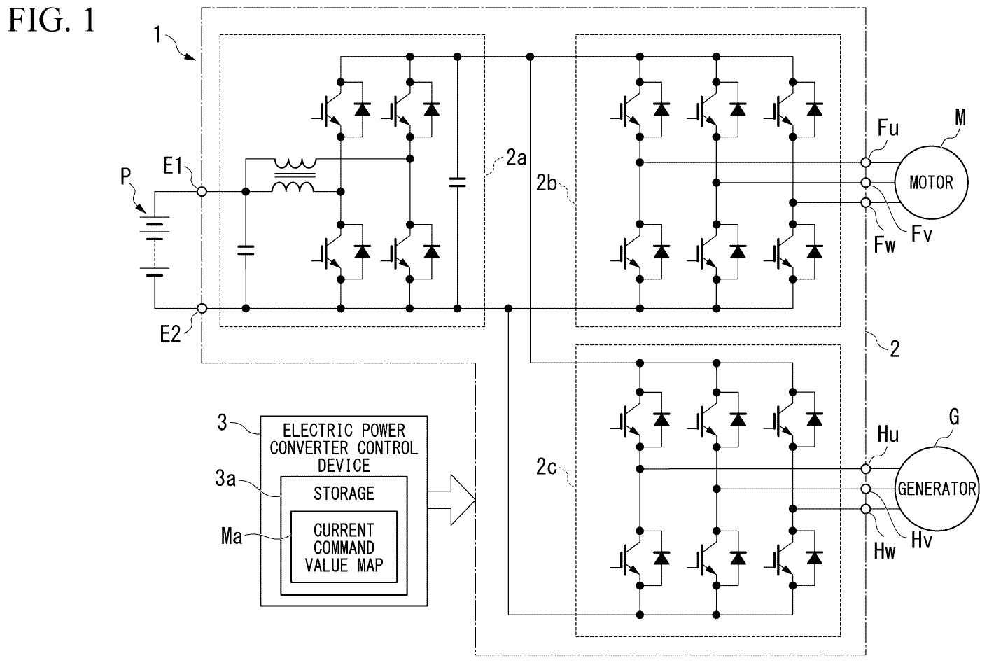

FIG. 1 is a circuit diagram schematically showing the schematic configuration of a motor control device 1 (electric power conversion device) according to the present embodiment. As shown in this figure, the motor control device 1 includes an electric power converter 2 and an electric power converter control device 3.

The electric power converter 2 is disposed between a motor M and a battery P (direct current electric power supply), and performs electric power conversion between the motor M and the battery P. As shown in FIG. 1, the electric power converter 2 includes a step-up/down converter 2a, a drive inverter 2b, and an electric power generation inverter 2c. The step-up/down converter 2a steps up a direct current voltage output from the battery P at a predetermined step-up ratio. In addition, the step-up/down converter 2a steps down a direct current voltage output from the drive inverter 2b or the electric power generation inverter 2c at a predetermined step-down ratio. As shown in FIG. 1, the step-up/down converter 2a includes, for example, a plurality of capacitors, a transformer, and a plurality of power semiconductor elements for voltage transformation. An insulated gate bipolar transistor (IGBT) or a metal oxide semiconductor field effect transistor (SiC-MOSFET) can be used as the power semiconductor element.

Such a step-up/down converter 2a is an electric power circuit known as a so-called magnetic coupling interleaved chopper circuit. The step-up/down converter 2a selectively performs a step-up operation of stepping up the direct current electric power input from the battery P via a pair of battery terminals and outputting the stepped-up direct current electric power to the drive inverter 2b, and a step-down operation of stepping down the direct current electric power input from the drive inverter 2b or the electric power generation inverter 2c and outputting the stepped-down direct current electric power to the battery P via the pair of battery terminals. That is, the step-up/down converter 2a is an electric power conversion circuit that inputs and outputs the direct current electric power bidirectionally between the battery P and the drive inverter 2b or the electric power generation inverter 2c.

The drive inverter 2b converts the direct current electric power output from the battery P into alternating current electric power based on a pulse width modulation (PWM) signal from the electric power converter control device 3 and supplies the alternating current electric power to the motor M. In addition, the drive inverter 2b converts the alternating current electric power output from the motor M into the direct current electric power based on the PWM signal from the electric power converter control device 3, and supplies the converted direct current electric power to the step-up/down converter 2a. As shown in FIG. 1, the drive inverter 2b has three switching legs and includes a total of six drive power semiconductor elements.

The drive inverter 2b includes three (plurality of) switching legs corresponding to the number of phases of the motor M. The drive inverter 2b is an electric power conversion circuit that selectively performs a powering operation and a regenerative operation. That is, the drive inverter 2b selectively performs the powering operation of converting the direct current electric power input from the step-up/down converter 2a into three-phase alternating current electric power and outputting the converted three-phase alternating current electric power to the motor M through three motor terminals, and the regenerative operation of converting the three-phase alternating current electric power input from the motor M through the three motor terminals into the direct current electric power and outputting the converted direct current electric power to the step-up/down converter 2a. That is, the drive inverter 2b is an electric power circuit that performs mutual conversion between the direct current electric power and the three-phase alternating current electric power between the step-up/down converter 2a and the motor M.

The electric power generation inverter 2c converts the alternating current electric power output from the generator G into the direct current electric power based on the PWM signal from the electric power converter control device 3 and supplies the converted direct current electric power to the step-up/down converter 2a. Such an electric power generation inverter 2c also has three switching legs and includes a total of six drive power semiconductor elements, similarly to the drive inverter 2b.

The electric power generation inverter 2c has three (plurality of) switching legs corresponding to the number of phases of the generator G. The electric power generation inverter 2c is an electric power conversion circuit that converts the three-phase alternating current electric power input from the generator G through three generator terminals into the direct current electric power and outputs the converted direct current electric power to the step-up/down converter 2a. That is, the electric power generation inverter 2c is an electric power circuit that performs mutual conversion between the direct current electric power and the three-phase alternating current electric power between the step-up/down converter 2a and the generator G.

As shown in the drawing, the battery P, the motor M, and the generator G are each connected to the electric power converter 2. The electric power converter 2 includes a pair of battery terminals (positive electrode battery terminal E1 and negative electrode battery terminal E2) to which the battery P is connected, as external connection terminals. In addition, the electric power converter 2 includes three motor terminals (U-phase motor terminal Fu, V-phase motor terminal Fv, and W-phase motor terminal Fw) to which the motor M is connected. In addition, the electric power converter 2 includes three generator terminals (U-phase generator terminal Hu, V-phase generator terminal Hv, and W-phase generator terminal Hw) to which the generator G is connected.

The motor control device 1 including such an electric power converter 2 is an electrical device provided in an electrified vehicle such as a hybrid vehicle or an electric vehicle, and controls the motor M that is a rotating machine and controls charging of the battery P with the alternating current electric power generated by the generator G. That is, the motor control device 1 performs drive control of the motor M based on the output (battery electric power) of the battery P and charge control of the battery P based on the output electric power (generated electric power) of the generator G.

It should be noted that the motor control device 1 can also be configured such that the electric power converter 2 does not include the electric power generation inverter 2c and the generator G is not connected to the electric power converter 2. In this case, the motor control device 1 performs the drive control of the motor M based on the output (battery electric power) of the battery P without performing the charge control of the battery P based on the output electric power (generated electric power) of the generator G.

Here, in the battery P, as shown in the drawing, a positive electrode is connected to the positive electrode battery terminal E1, and a negative electrode is connected to the negative electrode battery terminal E2. The battery P is a secondary battery such as a lithium ion battery, discharges the direct current electric power to the motor control device 1, charges the direct current electric power via the motor control device 1.

The motor M is a three-phase motor having “three” phases, and is a load of the drive inverter 2b. In this motor M, a U-phase input terminal is connected to the U-phase motor terminal Fu, a V-phase input terminal is connected to the V-phase motor terminal Fv, and a W-phase input terminal is connected to the W-phase motor terminal Fw. In such a motor M, a rotation shaft (drive shaft) is connected to wheels of the electrified vehicle, and the wheels are rotationally driven by applying rotational power to the wheels.

The generator G is a three-phase generator, and a U-phase output terminal is connected to the U-phase generator terminal Hu, a V-phase output terminal is connected to the V-phase generator terminal Hv, and a W-phase output terminal is connected to the W-phase generator terminal Hw. The generator G is connected to an output shaft of a power source such as an engine or the like mounted in the electrified vehicle, and outputs the three-phase alternating current electric power to the motor control device 1.

The electric power converter control device 3 includes a gate driver or an electronic control unit (ECU). The gate driver is a circuit that generates a gate signal based on various Duty command values (voltage transformation Duty command value, drive Duty command value, and electric power generation Duty command value) input from the ECU. For example, the gate driver generates a gate signal to be supplied to the step-up/down converter 2a based on the voltage transformation Duty command value input from the ECU. In addition, the gate driver generates a gate signal to be supplied to the drive inverter 2b based on the drive Duty command value input from the ECU. In addition, the gate driver generates a gate signal to be supplied to the electric power generation inverter 2c based on the electric power generation Duty command value input from the ECU.

The ECU is a control circuit that performs predetermined control processing based on a control program stored in advance. The ECU outputs various Duty command values (voltage transformation Duty command value, drive Duty command value, and electric power generation Duty command value) generated based on the control processing to the gate driver. Such an ECU performs the drive control of the motor M and the charge control of the battery P via the electric power converter 2 and the gate driver. That is, the ECU generates various Duty command values (voltage transformation Duty command value, drive Duty command value, and electric power generation Duty command value) related to the step-up/down converter 2a, the drive inverter 2b, and the electric power generation inverter 2c based on a detection value (voltage detection value) of a voltage sensor and a detection value (current detection value) of a current sensor, which are additionally provided in the step-up/down converter 2a, the drive inverter 2b, and the electric power generation inverter 2c, the operation information of the electrified vehicle, and the like.

In addition, as shown in FIG. 1, the electric power converter control device 3 includes a storage 3a. The storage 3a stores the above-described control program and various types of data. In the present embodiment, as shown in FIG. 1, the storage 3a stores a current command value map Ma. The current command value map Ma is a map used in a case in which the electric power converter control device 3 obtains a current command value for controlling the motor M. The current command value map Ma will be described in detail below.

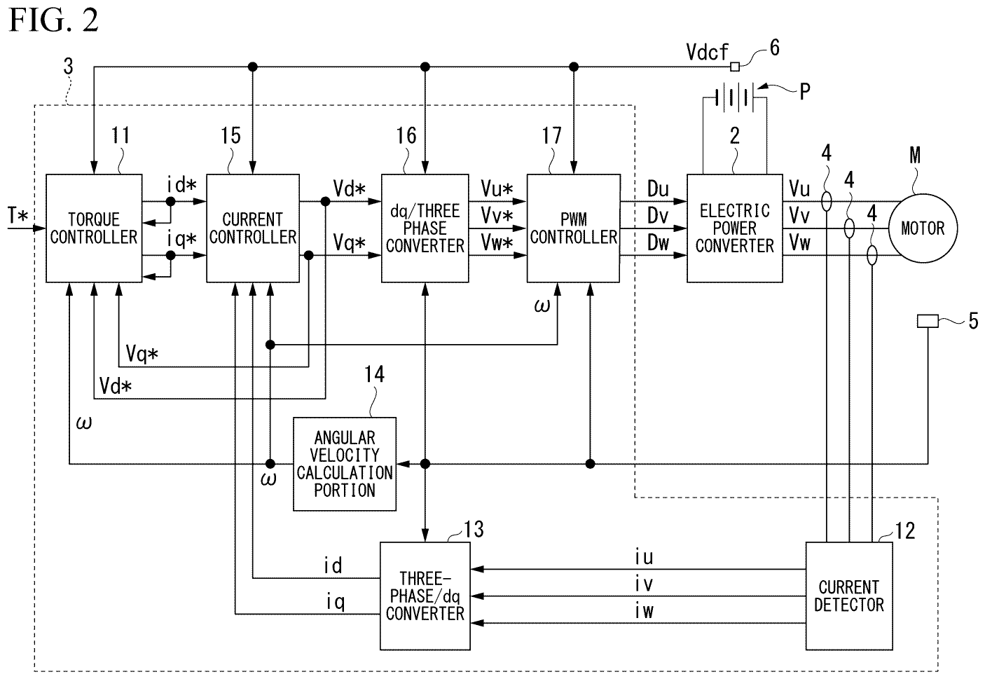

FIG. 2 is a block diagram showing a functional configuration of the electric power converter control device 3. The motor control device 1 includes a current sensor 4, a rotation angle sensor 5, and a voltage sensor 6, in addition to the electric power converter 2 and the electric power converter control device 3 as shown in FIG. 2.

The current sensor 4 detects each phase current between the motor M and the electric power converter 2, and outputs a detection result to the electric power converter control device 3. It should be noted that a plurality of current sensors 4 may be provided between the electric power converter 2 and the motor M, or may be provided inside the electric power converter 2. The current sensor 4 is not particularly limited as long as the current sensor 4 is configured to detect a phase current of each phase, and for example, includes a current transformer (CT) including a transformer or a Hall element. Further, the current sensor 4 may be a shunt resistor.

The rotation angle sensor 5 detects a rotation angle of the motor M. The rotation angle of the motor M is an electrical angle of the above-described rotor from a predetermined reference rotation position. The rotation angle sensor 5 outputs a detection signal indicating the detected rotation angle to the electric power converter control device 3. For example, the rotation angle sensor 5 may include a resolver. It should be noted that the rotational speed (motor rotational speed) of the motor M can be calculated based on the detection signal output from the rotation angle sensor 5. That is, the rotation angle sensor 5 outputs a detection signal including the motor rotational speed as information.

The voltage sensor 6 detects an output voltage of the battery P. In FIG. 2, the voltage sensor 6 is shown to be separated from the battery P, but, in practice, the voltage sensor 6 is connected to a wiring line connected to the battery P, and outputs a voltage value between the positive electrode and the negative electrode as a DC bus voltage value (direct current voltage detection value Vdcf).

The electric power converter control device 3 includes, for example, a torque controller 11, a current detector 12, a three-phase/dq converter 13, an angular velocity calculation portion 14, a current controller 15, a dq/three-phase converter 16, and a PWM controller 17 as functional portions to be embodied by the gate driver, the ECU, or the like described above.

The torque control unit 11 receives a pre-compensation torque command value T* from the outside. The torque controller 11 generates a d-axis current command value id* that is a target value of a d-axis current of the motor M and a q-axis current command value iq* that is a target value of a q-axis current of the motor M, based on the pre-compensation torque command value T*. Further, the torque controller 11 outputs the generated d-axis current command value id* and q-axis current command value iq* to the current controller 15.

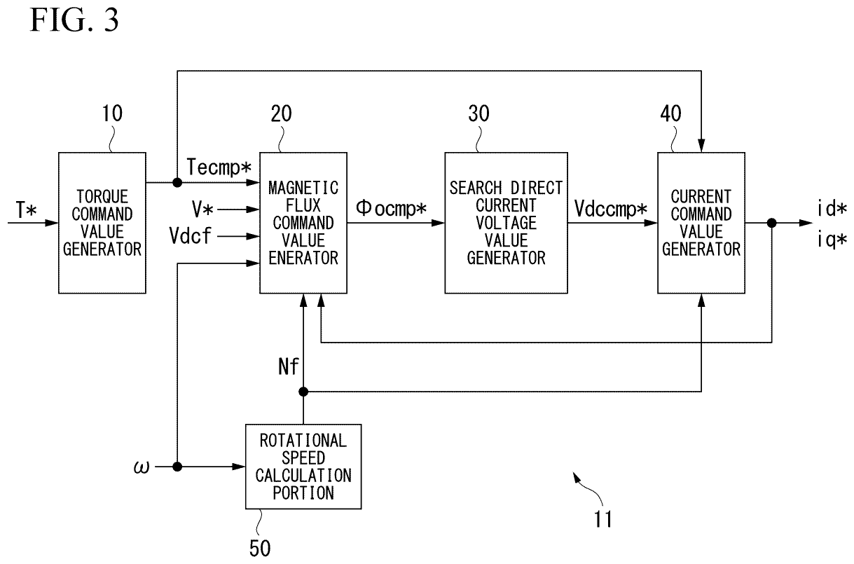

FIG. 3 is a block diagram showing a functional configuration of the torque controller 11. As shown in this figure, in the present embodiment, the torque controller 11 includes a torque command value generator 10, a magnetic flux command value generator 20, a search direct current voltage value generator 30, a current command value generator 40, and a rotational speed calculation portion 50.

The torque command value generator 10 generates a post-compensation torque command value Tecmp* from the pre-compensation torque command value T* based on a torque feedback value calculated based on a state of the motor M. It should be noted that the method of calculating the torque feedback value is not particularly limited. For example, the torque feedback value can be obtained based on a value indicating the state of the motor M (for example, a state of output torque or a state of a temperature) acquired by a detector (not shown). The post-compensation torque command value Tecmp* is a torque command value obtained by correcting the pre-compensation torque command value T* in accordance with an actual output torque based on the torque feedback value.

In the present embodiment, the post-compensation torque command value Tecmp* is input as the torque command value to the magnetic flux command value generator 20 or the current command value generator 40. However, it is not always necessary to generate the post-compensation torque command value Tecmp* from the pre-compensation torque command value T*. That is, the pre-compensation torque command value T* can also be input as the torque command value to the magnetic flux command value generator 20 or the current command value generator 40. In this case, it is also possible not to provide the torque command value generator 10.

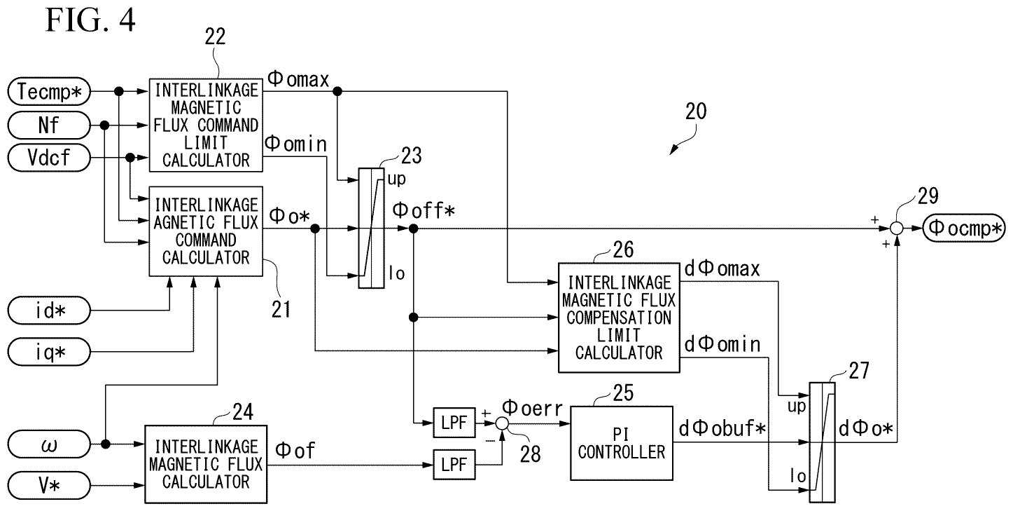

The magnetic flux command value generator 20 generates a magnetic flux command value (in the present embodiment, a post-compensation magnetic flux command value Φocmp* described below) based on the post-compensation torque command value Tecmp*. FIG. 4 is a block diagram of the magnetic flux command value generator 20. As shown this figure, the magnetic flux command value generator 20 includes an interlinkage magnetic flux command calculator 21, an interlinkage magnetic flux command limit calculator 22, an interlinkage magnetic flux command limit restriction portion 23, an interlinkage magnetic flux calculator 24, a PI controller 25, an interlinkage magnetic flux compensation limit calculator 26, and an interlinkage magnetic flux compensation limit restriction portion 27.

The interlinkage magnetic flux command calculator 21 calculates a pre-compensation interlinkage magnetic flux command value Φo* (pre-compensation magnetic flux command value) based on the post-compensation torque command value Tecmp*. For example, a motor rotational speed Nf (rotation detection value) indicating the rotational speed of the motor M is input to the interlinkage magnetic flux command calculator 21 from the rotational speed calculation portion 50 shown in FIG. 3. The motor rotational speed Nf is a value calculated by the rotational speed calculation portion 50 based on angular velocity ω as will be described below. Further, the angular velocity ω is calculated based on an output value of the rotation angle sensor 5. Therefore, the motor rotational speed Nf is the rotation detection value indicating the rotational speed of the motor M. Similarly, the angular velocity ω is also the rotation detection value indicating the rotational speed of the motor M.

Further, the direct current voltage detection value Vdcf is input to the interlinkage magnetic flux command calculator 21. For example, the interlinkage magnetic flux command calculator 21 obtains a modulation rate coefficient gmref to be used in the electric power converter 2 based on a map for obtaining the modulation rate coefficient gmref using the post-compensation torque command value Tecmp*, the motor rotational speed Nf, and the direct current voltage detection value Vdcf as parameters. Further, the interlinkage magnetic flux command calculator 21 calculates the pre-compensation interlinkage magnetic flux command value Φo* based on the modulation rate coefficient gmref, the motor rotational speed Nf, and the direct current voltage detection value Vdcf.

In addition, the interlinkage magnetic flux command calculator 21 calculates a magnetic flux estimation error αε based on the modulation rate coefficient gmref, the post-compensation torque command value Tecmp*, the angular velocity ω, the direct current voltage detection value Vdcf, the d-axis current command value id* (current command value), the q-axis current command value iq* (current command value), and a minimum armature resistance value Ramin. Further, the interlinkage magnetic flux command calculator 21 obtains the pre-compensation interlinkage magnetic flux command value Φo* by using the magnetic flux estimation error αε.

Formula (1) is an example of a formula for calculating the magnetic flux estimation error αε. Further, Δεfx in Formula (1) can be calculated by, for example, Formula (2). Further, the pre-compensation interlinkage magnetic flux command value Φo* can be calculated by, for example, Formula (3). It should be noted that kv1ω in Formulas (1) and (3) is a value obtained by Formula (4). It should be noted that the minimum armature resistance value Ramin is stored in the storage 3a in advance, for example.

$$\begin{matrix}[ Formula 1 ] & \\ αε = - \frac{1}{2} Δε fx - \frac{1}{8} Δε {fx}^{2} & ( 1 )\end{matrix}$$

$$\begin{matrix}[ Formula 2 ] & \\ {{Δε fx = \frac{Ra min}{kv 1 {ω}^{2} {Vdcf}^{2}} [ 4 π \frac{Nf}{60} Tecmp * + Ra min \{ ( id \text{*)}}^{2} + ( iq \text{*)}}^{2} \} ] & ( 2 )\end{matrix}$$

$$\begin{matrix}[ Formula 3 ] & \\ Φ o *= \frac{kv 1 ω}{ω} ( 1 + αε ) Vdcf & ( 3 )\end{matrix}$$

$$\begin{matrix}[ Formula 4 ] & \\ kv 1 ω = gmref \times \frac{1}{\sqrt{2}} & ( 4 )\end{matrix}$$

For example, the interlinkage magnetic flux command calculator 21 calculates the magnetic flux estimation error αε based on Formula (1) and Formula (2). In addition, the interlinkage magnetic flux command calculator 21 calculates the pre-compensation interlinkage magnetic flux command value Φo* based on Formula (3).

The interlinkage magnetic flux command limit calculator 22 calculates an interlinkage magnetic flux command upper limit value Φomax and an interlinkage magnetic flux command lower limit value ψomin based on the post-compensation torque command value Tecmp*, the motor rotational speed Nf, and the direct current voltage detection value Vdcf. The interlinkage magnetic flux command upper limit value Φomax (maximum interlinkage magnetic flux value) is a maximum interlinkage magnetic flux value that can be set for the post-compensation torque command value Tecmp* with the premise that field control can be performed. In addition, the interlinkage magnetic flux command lower limit value ψomin is a minimum interlinkage magnetic flux value that can be set for the post-compensation torque command value Tecmp* with the premise that the field control can be performed.

For example, the interlinkage magnetic flux command limit calculator 22 obtains the interlinkage magnetic flux command upper limit value Φomax based on an interlinkage magnetic flux restriction map for field control indicating the maximum value of the interlinkage magnetic flux command value for each value of the post-compensation torque command value Tecmp*. It should be noted that, as the interlinkage magnetic flux command lower limit value ψomin, a predetermined value may be used without calculation.

The interlinkage magnetic flux command limit restriction portion 23 restricts an upper limit value and a lower limit value of the pre-compensation interlinkage magnetic flux command value Φo* calculated by the interlinkage magnetic flux command calculator 21 based on the interlinkage magnetic flux command upper limit value Φomax and the interlinkage magnetic flux command lower limit value ψomin that are calculated by the interlinkage magnetic flux command limit calculator 22. That is, in a case in which the pre-compensation interlinkage magnetic flux command value Φo* input from the interlinkage magnetic flux command calculator 21 is larger than the interlinkage magnetic flux command upper limit value Φomax, the interlinkage magnetic flux command limit restriction unit 23 replaces a value of the pre-compensation interlinkage magnetic flux command value Φo* with a value of the interlinkage magnetic flux command upper limit value Φomax and outputs the replaced value. In addition, in a case in which the pre-compensation interlinkage magnetic flux command value Φo* input from the interlinkage magnetic flux command calculator 21 is smaller than the interlinkage magnetic flux command lower limit value ψomin, the interlinkage magnetic flux command limit restriction unit 23 replaces the value of the pre-compensation interlinkage magnetic flux command value Φo* with the value of the interlinkage magnetic flux command lower limit value ψomin and outputs the replaced value. It should be noted that the pre-compensation interlinkage magnetic flux command value Φo* output from the interlinkage magnetic flux command limit restriction portion 23 is referred to as a pre-compensation interlinkage magnetic flux command value Φoff*.

The interlinkage magnetic flux calculator 24 calculates an interlinkage magnetic flux feedback value Φof (magnetic flux feedback value) based on the angular velocity ω. For example, a voltage command value V* (d-axis voltage command value Vd* and q-axis voltage command value Vq*) is feedback-input to the interlinkage magnetic flux calculator 24 from the current controller 15 shown in FIG. 2. The interlinkage magnetic flux calculator 24 calculates the interlinkage magnetic flux feedback value Φof based on the angular velocity ω indicating a current motor rotational speed input from the angular velocity calculation portion 14 and a current voltage command value V* input from the current controller 15.

The PI controller 25 calculates a magnetic flux compensation value dΦobuf* based on a deviation Φoerr between the pre-compensation interlinkage magnetic flux command value Φoff* and the interlinkage magnetic flux feedback value Φof. The deviation Φoerr obtained by a subtractor 28 is input. The subtractor 28 calculates the deviation Φoerr by subtracting the interlinkage magnetic flux feedback value Φof input through a low-pass filter (LPF) from the pre-compensation interlinkage magnetic flux command value Φoff* input through the low-pass filter (LPF).

The PI controller 25 calculates the magnetic flux compensation value dΦobuf* by adding a value obtained by multiplying the deviation Φoerr with a proportional gain and a value obtained by multiplying the deviation Φoerr with an integral gain and then integrating the multiplied value. As described above, the PI controller 25 calculates the magnetic flux compensation value dΦobuf* based on the calculation using the proportional gain and the calculation using the integral gain.

It should be noted that a feedback-type anti-windup processing may be performed so that the integral term is not saturated. In this case, a value obtained by subtracting a magnetic flux compensation value dΦo* described below, which is output from the interlinkage magnetic flux compensation limit restriction unit 27, from the pre-compensation interlinkage magnetic flux command value Φoff* output from the PI controller 25 is obtained. In addition, calculation is performed in which a value obtained by multiplying the reciprocal of the proportional gain used in the PI controller 25 with respect to this value is subtracted from the deviation ⋅oerr, and then multiplied by the integral gain as described above.

The interlinkage magnetic flux compensation limit calculator 26 calculates a restriction value used in the interlinkage magnetic flux compensation limit restriction portion 27. Here, the interlinkage magnetic flux compensation limit restriction portion 27 calculates an upper restriction value dΦomax that restricts an upper limit value of the magnetic flux compensation value dΦobuf*. The calculated upper restriction value dΦomax is supplied to the interlinkage magnetic flux compensation limit restriction portion 27. In addition, the interlinkage magnetic flux compensation limit calculator 26 calculates a lower restriction value dΦomin that restricts a lower limit value of the magnetic flux compensation value dΦobuf*. The calculated lower restriction value dΦomin is supplied to the interlinkage magnetic flux compensation limit restriction portion 27.

For example, the interlinkage magnetic flux compensation limit calculator 26 calculates the upper restriction value dΦomax and the lower restriction value dΦomin based on the pre-compensation interlinkage magnetic flux command value Φo* input from the interlinkage magnetic flux command calculator 21 and the interlinkage magnetic flux command upper limit value Φomax input from the interlinkage magnetic flux command limit calculator 22.

The restriction of the magnetic flux compensation value dΦobuf* by the interlinkage magnetic flux compensation limit restriction portion 27, which will be described below, is useful in a case in which the motor M is subjected to field weakening control. In addition, in a case in which the pre-compensation interlinkage magnetic flux command value Φo* is smaller than the interlinkage magnetic flux command upper limit value Φomax, it can be determined that the field weakening control is required. Therefore, in a case in which the pre-compensation interlinkage magnetic flux command value Φo* is smaller than the interlinkage magnetic flux command upper limit value Φomax, the interlinkage magnetic flux compensation limit calculator 26 calculates the upper restriction value dΦomax and the lower restriction value dΦomin such that the upper limit value and the lower limit value of the magnetic flux compensation value dΦobuf* are restricted. That is, in a case in which the pre-compensation interlinkage magnetic flux command value Φo* is larger than the interlinkage magnetic flux command upper limit value Φomax and the field weakening control is not required, the interlinkage magnetic flux compensation limit calculator 26 sets the upper restriction value dΦomax and the lower restriction value dΦomin such that the upper limit value and the lower limit value of the magnetic flux compensation value dΦobuf* are zero.

It should be noted that the interlinkage magnetic flux compensation limit calculator 26 may calculate the upper restriction value dΦomax and the lower restriction value dΦomin by using the pre-compensation interlinkage magnetic flux command value Φoff* output from the interlinkage magnetic flux command limit restriction portion 23 instead of the pre-compensation interlinkage magnetic flux command value Φo*. In addition, the upper restriction value dΦomax and the lower restriction value dΦomin may be calculated by using the pre-compensation interlinkage magnetic flux command value Φo* and the pre-compensation interlinkage magnetic flux command value Φoff*.

The interlinkage magnetic flux compensation limit restriction portion 27 restricts the upper limit value and the lower limit value of the magnetic flux compensation value dΦobuf* based on the restriction value. Here, the interlinkage magnetic flux compensation limit restriction portion 27 restricts the upper limit value and the lower limit value of the magnetic flux compensation value dΦobuf* based on the upper restriction value dΦomax and the lower restriction value dΦomin input from the interlinkage magnetic flux compensation limit calculator 26.

That is, in a case in which the magnetic flux compensation value dΦobuf* input from the PI controller 25 is larger than the upper restriction value dΦomax, the interlinkage magnetic flux compensation limit restriction portion 27 replaces the value of the magnetic flux compensation value dΦobuf* with the upper restriction value dΦomax and outputs the replaced value. In addition, in a case in which the magnetic flux compensation value dΦobuf* input from the PI controller 25 is smaller than the lower restriction value dΦomin, the interlinkage magnetic flux compensation limit restriction portion 27 replaces the value of the magnetic flux compensation value dΦobuf* with the lower restriction value dΦomin and outputs the replaced value. It should be noted that the magnetic flux compensation value dΦobuf* output from the interlinkage magnetic flux compensation limit restriction portion 27 is referred to as the magnetic flux compensation value dΦo*.

In addition, as shown in FIG. 4, the magnetic flux command value generator 20 includes an adder 29 that adds the pre-compensation interlinkage magnetic flux command value Φoff* and the magnetic flux compensation value dΦo* and calculates the post-compensation magnetic flux command value Φocmp* to output the calculated post-compensation magnetic flux command value Φocmp*. That is, the adder 29 calculates the post-compensation magnetic flux command value Φocmp* from the pre-compensation interlinkage magnetic flux command value Φoff* based on the magnetic flux compensation value dΦo*.

In the magnetic flux command value generation unit 20 configured as described above, the post-compensation torque command value Tecmp*, the motor rotational speed Nf, the angular velocity ω, and the direct current voltage detection value Vdcf are input to the interlinkage magnetic flux command calculator 21. In the interlinkage magnetic flux command calculator 21, the pre-compensation interlinkage magnetic flux command value Φo* is obtained based on the post-compensation torque command value Tecmp*, the motor rotational speed Nf, the angular velocity ω, and the direct current voltage detection value Vdcf.

Meanwhile, the post-compensation torque command value Tecmp*, the motor rotational speed Nf, and the direct current voltage detection value Vdcf are also input to the interlinkage magnetic flux command limit calculator 22. In the interlinkage magnetic flux command limit calculator 22, the interlinkage magnetic flux command upper limit value Φomax and the interlinkage magnetic flux command lower limit value Φomin are obtained based on the post-compensation torque command value Tecmp*, the motor rotational speed Nf, and the direct current voltage detection value Vdcf.

The pre-compensation interlinkage magnetic flux command value Φo* is restricted to a value based on the interlinkage magnetic flux command upper limit value Φomax or the interlinkage magnetic flux command lower limit value ψomin in the interlinkage magnetic flux command limit restriction portion 23 as necessary, and is output as the pre-compensation interlinkage magnetic flux command value Φoff*.

In addition, the angular velocity ω and the voltage command value V* are input to the interlinkage magnetic flux calculator 24. In the interlinkage magnetic flux calculator 24, the interlinkage magnetic flux feedback value Φof is calculated based on the angular velocity ω and the voltage command value V*.

The pre-compensation interlinkage magnetic flux command value Φoff* is input to the subtractor 28 via the low-pass filter. In addition, the interlinkage magnetic flux feedback value Φof is also input to the subtractor 28 via the low-pass filter. In the subtractor 28, the deviation Φoerr is calculated by subtracting the interlinkage magnetic flux feedback value Φof from the pre-compensation interlinkage magnetic flux command value Φoff*.

The deviation Φoerr is input to the PI controller 25. The PI controller 25 calculates the magnetic flux compensation value dΦobuf* by adding the value obtained by multiplying the deviation Φoerr with the proportional gain and the value obtained by multiplying the deviation Φoerr with the integral gain and then integrating the multiplied value.

Meanwhile, the pre-compensation interlinkage magnetic flux command value Φo* output from the interlinkage magnetic flux command calculator 21 and the interlinkage magnetic flux command upper limit value Φomax output from the interlinkage magnetic flux command limit calculator 22 are input to the interlinkage magnetic flux compensation limit calculator 26. In the interlinkage magnetic flux compensation limit calculator 26, the upper restriction value dΦomax, which restricts the upper limit value of the magnetic flux compensation value dΦobuf*, is calculated based on the pre-compensation interlinkage magnetic flux command value Φo* and the interlinkage magnetic flux command upper limit value Φomax. In addition, in the interlinkage magnetic flux compensation limit calculator 26, the lower restriction value dΦomin, which restricts the lower limit value of the magnetic flux compensation value dΦobuf*, is calculated based on the pre-compensation interlinkage magnetic flux command value Φo* and the interlinkage magnetic flux command upper limit value Φomax.

The magnetic flux compensation value dΦobuf* output from the PI controller 25 is restricted in the interlinkage magnetic flux compensation limit restriction portion 27 based on the upper restriction value dΦomax or the lower restriction value dΦomin as necessary, and is output as the magnetic flux compensation value dΦo*.

The pre-compensation interlinkage magnetic flux command value Φoff* output from the interlinkage magnetic flux command limit restriction portion 23 and the magnetic flux compensation value dΦo* output from the interlinkage magnetic flux compensation limit restriction portion 27 are input to the adder 29. In the adder 29, the pre-compensation interlinkage magnetic flux command value Φoff* and the magnetic flux compensation value dΦo* are added to calculate the post-compensation magnetic flux command value Φocmp*. The calculated post-compensation magnetic flux command value Φocmp* is input to the search direct current voltage value generator 30 shown in FIG. 2.

In the present embodiment, this post-compensation magnetic flux command value Φocmp* is input, as the magnetic flux command value, to the search direct current voltage value generator 30. That is, in the present embodiment, the magnetic flux command value obtained by using the interlinkage magnetic flux feedback value Φof (magnetic flux feedback value) is input to the search direct current voltage value generator 30. Therefore, the search direct current voltage value generator 30 can obtain a search direct current voltage value Vdccmp* including components caused by the interlinkage magnetic flux feedback value Φof. However, the pre-compensation interlinkage magnetic flux command value Φoff* can also be input, as the magnetic flux command value, to the search direct current voltage value generator 30.

The search direct current voltage value generator 30 obtains a direct current voltage value (search direct current voltage value Vdccmp*) for obtaining the d-axis current command value id* and the q-axis current command value iq* based on the modulation rate coefficient gmref and the post-compensation magnetic flux command value Φocmp*. The search direct current voltage value Vdccmp* can also be obtained by using only the modulation rate coefficient gmref and the post-compensation magnetic flux command value Φocmp* as parameters. However, in the present embodiment, the search direct current voltage value generator 30 obtains the search direct current voltage value Vdccmp* based on the direct current voltage detection value Vdcf and the angular velocity ω, in addition to the modulation rate coefficient gmref and the post-compensation magnetic flux command value Φocmp*. The search direct current voltage value generator 30 can obtain, for example, the search direct current voltage value Vdccmp* based on Formula (5).

$$\begin{matrix}[ Formula 5 ] & \\ Vdccmp *= \frac{ω}{kv 1 ω} Φ ocmp * & ( 5 )\end{matrix}$$

Here, a derivation method of Formula (5) will be described. The pre-compensation interlinkage magnetic flux command value Φoff* can be represented by Formula (6). In addition, the post-compensation magnetic flux command value Φocmp* can be represented by Formula (7).

$$\begin{matrix}[ Formula 6 ] & \\ Φoff *= \frac{gmref}{\sqrt{2}} \sqrt{\frac{1}{{ω}^{2}}} Vdcf = ( \frac{gmref}{\sqrt{2}} ) \frac{Vdcf}{\vert ω \vert} & ( 6 )\end{matrix}$$

$$\begin{matrix}[ Formula 7 ] & \\ Φ ocmp *= Φoff * + d Φ o *= ( \frac{gmref}{\sqrt{2}} ) \frac{Vdcf}{\vert ω \vert} + ( \frac{gmref}{\sqrt{2}} ) \frac{Δ Vh}{\vert ω \vert} = \frac{1}{\vert ω \vert} ( \frac{gmref}{\sqrt{2}} ) ( Vdcf + Δ Vh ) & ( 7 )\end{matrix}$$

Here, ΔVh in Formula (7) is a voltage component included in the magnetic flux compensation value dΦo*. It is possible to calculate the voltage component ΔVh based on the modulation rate coefficient gmref and the angular velocity ω. As shown in Formula (8), a value obtained by adding the voltage component ΔVh to the direct current voltage detection value Vdcf as the direct current voltage correction value is the search direct current voltage value Vdccmp*. Therefore, the search direct current voltage value Vdccmp* can be represented as shown in Formula (5).

$$\begin{matrix}[ Formula 8 ] & \\ Vdccmp *= Vdcf + Δ Vh = \vert ω \vert ( \frac{\sqrt{2}}{gmref} ) Φ ocmp * & ( 8 )\end{matrix}$$

As shown in Formula (8), the search direct current voltage value Vdccmp* includes the voltage component ΔVh based on the magnetic flux compensation value dΦo* (interlinkage magnetic flux feedback value Φof (magnetic flux feedback value)). The search direct current voltage value Vdccmp* is used for obtaining the d-axis current command value id* and the q-axis current command value iq*. Therefore, by obtaining the d-axis current command value id* and the q-axis current command value iq* based on the search direct current voltage value Vdccmp*, the d-axis current command value id* and the q-axis current command value iq* in consideration of the interlinkage magnetic flux feedback value Φof can be obtained.

In the present embodiment, the search direct current voltage value generator 30 obtains the search direct current voltage value Vdccmp* by using Formula (5) as described above. That is, the search direct current voltage value generator 30 obtains the search direct current voltage value Vdccmp* including the voltage component ΔVh (direct current voltage correction value) based on the interlinkage magnetic flux feedback value Φof.

Returning to FIG. 3, the current command value generator 40 obtains the d-axis current command value id* and the q-axis current command value iq* based on the post-compensation torque command value Tecmp*, the motor rotational speed Nf, and the search direct current voltage value Vdccmp*. More specifically, the current command value generator 40 obtains the d-axis current command value id* and the q-axis current command value iq* corresponding to the post-compensation torque command value Tecmp*, the motor rotational speed Nf, and the search direct current voltage value Vdccmp* by using the current command value map Ma stored in the storage 3a.

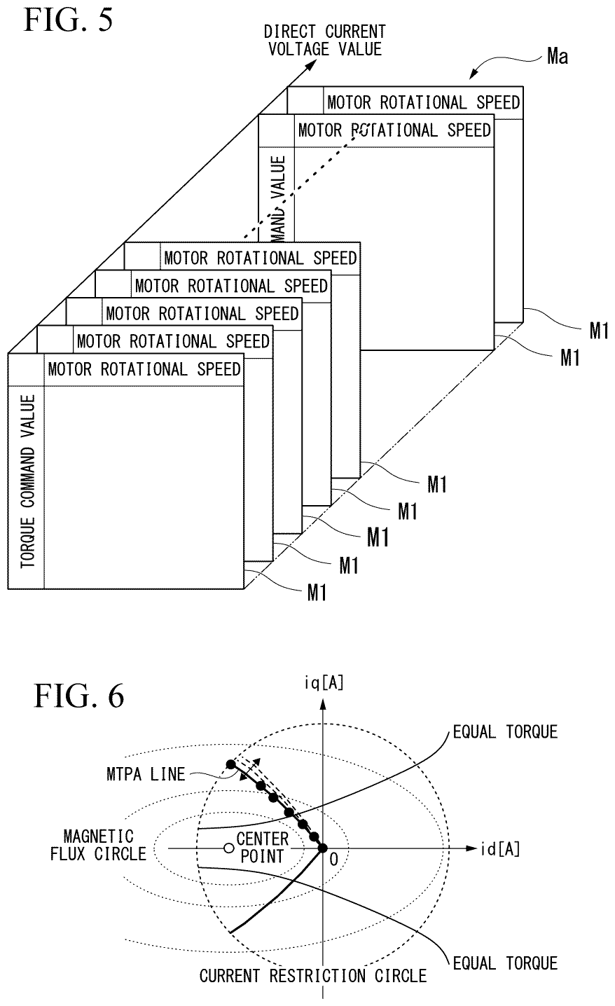

FIG. 5 is a conceptual diagram of the current command value map Ma. As shown in FIG. 5, the current command value map Ma is a three-dimensional map in which a plurality of two-dimensional maps M1 are provided in accordance with the direct current voltage value. For example, one two-dimensional map M1 is provided for each direct current voltage value of 1 V. It should be noted that the number of volts at which the two-dimensional map M1 is provided can be optionally changed for the direct current voltage value. Each two-dimensional map M1 is a map in which the post-compensation torque command value Tecmp* and the motor rotational speed Nf are used as parameters, and the d-axis current command value id* and the q-axis current command value iq* are associated with the post-compensation torque command value Tecmp* and the motor rotational speed Nf.

The current command value generator 40 refers to the current command value map Ma to obtain the d-axis current command value id* and the q-axis current command value iq* based on the input post-compensation torque command value Tecmp*, the motor rotational speed Nf, and the search direct current voltage value Vdccmp*.

The rotational speed calculation portion 50 calculates the motor rotational speed Nf from the angular velocity ω input from the angular velocity calculation portion 14. It should be noted that the rotational speed calculation portion 50 may calculate the motor rotational speed Nf from the electrical angle acquired from the rotation angle sensor 5. The rotational speed calculation portion 50 outputs the calculated motor rotational speed Nf to the magnetic flux command value generator 20 and the current command value generator 40.

It should be noted that, in the present embodiment, the torque controller 11 includes the rotational speed calculation portion 50. However, the rotational speed calculation portion 50 can be provided outside the torque controller 11. Further, it is also possible to change the motor rotational speed Nf, which is one of the parameters of the current command value map Ma, to the angular velocity ω. That is, the current command value map Ma need only be a map in which the rotation detection values indicating the rotational speed of the motor, such as the motor rotational speed Nf, the angular velocity ω, or the like, are used as parameters. For example, in a case in which the motor rotational speed Nf, which is one of the parameters of the current command value map Ma, is changed to the angular velocity ω, the motor rotational speed Nf, which is calculated by the rotational speed calculation portion 50, need not be input to the current command value generator 40.

Returning to FIG. 2, the current detector 12 detects a current value (hereinafter, referred to as a “U-phase current value”) iu flowing through a U-phase coil in the motor M, a current value (hereinafter, referred to as a “V-phase current value”) iv flowing through a V-phase coil in the motor M, and a current value (hereinafter, referred to as a “W-phase current value”) iw flowing through a W-phase coil in the motor M from the detection result of each current sensor 4. Then, the current detector 12 outputs the detected U-phase current value iu, V-phase current value iv, and W-phase current value iw to the three-phase/dq converter 13.

The three-phase/dq converter 13 converts the U-phase current value iu, the V-phase current value iv, and the W-phase current value iw, which are acquired from the current detector 12, into a d-axis current value id and a q-axis current value iq in a dq coordinate system by using the electrical angle acquired from the rotation angle sensor 5. The three-phase/dq converter 13 outputs the d-axis current value id and the q-axis current value iq to the current controller 15.

The angular velocity calculation portion 14 calculates the angular velocity ω (rotation detection value) based on the electrical angle of the motor M output from the rotation angle sensor 5. The angular velocity calculation portion 14 outputs the calculated angular velocity ω to the current controller 15. The current controller 15 calculates the d-axis voltage command value Vd* based on the d-axis current command value id*. The current controller 15 calculates the q-axis voltage command value Vq* based on the q-axis current command value iq*.

The current controller 15 outputs the d-axis voltage command value Vd* and the q-axis voltage command value Vq* to the dq/three-phase converter 16.

The dq/three-phase converter 16 acquires the electrical angle from the rotation angle sensor 5. The dq/three-phase converter 16 acquires the d-axis voltage command value Vd* and the q-axis voltage command value Vq* from the current controller 15. The dq/three-phase converter 16 converts the d-axis voltage command value Vd* and the q-axis voltage command value Vq* into a U-phase voltage command value Vu*, a V-phase voltage command value Vv*, and a W-phase voltage command value Vw*, which are the voltage command values of each phase of the UVW-phase in the motor M, by using the electrical angle. Then, the dq/three-phase converter 16 outputs the U-phase voltage command value Vu*, the V-phase voltage command value Vv*, and the W-phase voltage command value Vw* to the PWM controller 17. The U-phase voltage command value Vu*, the V-phase voltage command value Vv*, and the W-phase voltage command value Vw* are modulation waves, and may be referred to as “voltage command signals” in a case in which the U-phase voltage command value Vu*, the V-phase voltage command value Vv*, and the W-phase voltage command value Vw* are not distinguished from each other.

The PWM controller 17 compares a carrier wave having a predetermined carrier frequency with the voltage command signal. Then, the PWM controller 17 outputs the PWM signal to the electric power converter 2 by outputting a signal of a Hi level in a period in which the amplitude of the voltage command signal is larger than that of the carrier wave and outputting a signal of a Lo level in a period in which the amplitude of the voltage command signal is smaller than that of the carrier wave, as a result of the comparison. The PWM controller 17 generates the PWM signal Du by comparing the carrier wave with the U-phase voltage command value Vu*, and outputs the generated PWM signal Du to the electric power converter 2. The PWM controller 17 generates the PWM signal Dv by comparing the carrier wave with the V-phase voltage command value Vv*, and outputs the generated PWM signal Dv to the electric power converter 2. The PWM controller 17 generates the PWM signal Dw by comparing the carrier wave with the W-phase voltage command value Vw*, and outputs the generated PWM signal Dw to the electric power converter 2.

The electric power converter 2 is driven based on the PWM signals (PWM signal Du, PWM signal Dv, and PWM signal Dw, as described above) input from the PWM controller 17, to control the rotation of the motor M.

In the motor control device 1 according to the present embodiment, the torque command value generator 10 generates the post-compensation torque command value Tecmp* from the pre-compensation torque command value T* based on the torque feedback value. The post-compensation torque command value Tecmp* is input to the magnetic flux command value generator 20 and the current command value generator 40. In the magnetic flux command value generator 20, the post-compensation magnetic flux command value Φocmp* is generated based on the post-compensation torque command value Tecmp*. The post-compensation magnetic flux command value Φocmp* is input to the search direct current voltage value generator 30.

In the search direct current voltage value generator 30, the search direct current voltage value Vdccmp* is obtained based on the modulation rate coefficient gmref and the post-compensation magnetic flux command value Φocmp*. The search direct current voltage value Vdccmp* is input to the current command value generator 40. The current command value generator 40 obtains the d-axis current command value id* and the q-axis current command value iq* based on the post-compensation torque command value Tecmp*, the motor rotational speed Nf, and the search direct current voltage value Vdccmp*.

The electric power converter control device 3 provided in the motor control device 1 according to the present embodiment as described above performs electric power conversion between the battery P and the motor M. The electric power converter control device 3 according to the present embodiment includes the magnetic flux command value generator 20, the search direct current voltage value generator 30, and the current command value generator 40. The magnetic flux command value generator 20 obtains the post-compensation magnetic flux command value Φocmp* based on the post-compensation torque command value Tecmp* and the motor rotational speed Nf indicating the rotational speed of the motor. The search direct current voltage value generator 30 obtains the search direct current voltage value Vdccmp* based on at least the modulation rate coefficient gmref and the post-compensation magnetic flux command value Φocmp* that are targeted by the electric power converter 2. The current command value generator 40 obtains the current command values (d-axis current command value id* and q-axis current command value iq*) for controlling the motor, based on the post-compensation torque command value Tecmp*, the motor rotational speed Nf, and the search direct current voltage value Vdccmp*.

That is, the electric power converter control device 3 according to the present embodiment obtains the current command values based on the motor rotational speed Nf indicating the rotational speed of the motor and the search direct current voltage value Vdccmp* indicating the output voltage of the battery P. Therefore, the electric power converter control device 3 according to the present embodiment can obtain the current command values in accordance with any one or both of the motor rotational speed Nf and the search direct current voltage value Vdccmp*. Therefore, even in a case in which both the rotational speed of the motor M and the output voltage of the battery P are changed, the electric power converter control device 3 according to the present embodiment can reduce the difference between the post-compensation torque command value Tecmp* and the output torque, and can improve the torque accuracy with respect to the post-compensation torque command value Tecmp*.

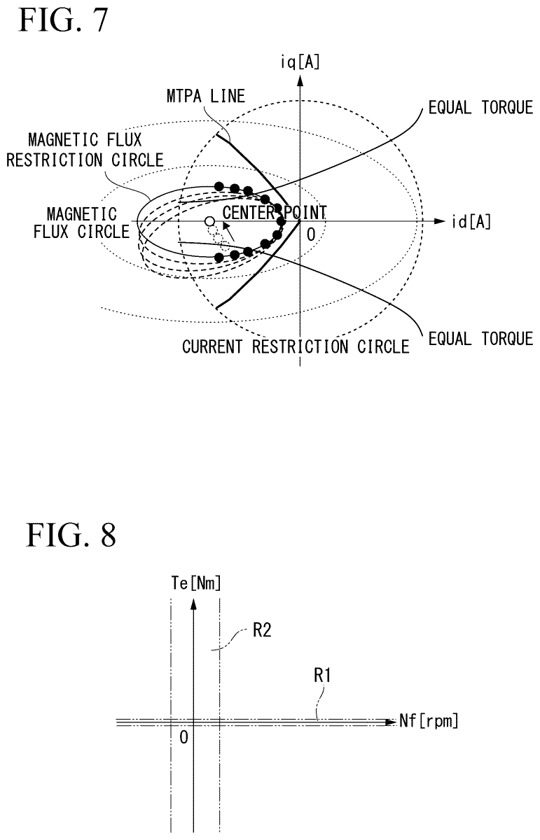

FIGS. 6 and 7 are schematic diagrams showing the operations and effects of the electric power converter control device 3 according to the present embodiment. FIGS. 6 and 7 are schematic diagrams showing transitions of a current operating point in an id-iq plane. For example, as shown in FIG. 6, in a case in which the motor M is driven at the maximum output, the current operating point is changed along a minimum current maximum torque line (MTPA line) that has the highest efficiency. In a case in which, in the control, such a minimum current maximum torque line is set to be only one without depending on the motor rotational speed Nf and the output voltage of the battery P, the torque accuracy cannot be ensured in a case in which an actual minimum current maximum torque line is changed as shown by a broken line in FIG. 6 in accordance with the motor rotational speed Nf or the state of the output voltage of the battery P. On the other hand, in the electric power converter control device 3 according to the present embodiment, the minimum current maximum torque line can be set to be different in the control in accordance with the motor rotational speed Nf or the state of the output voltage of the battery P. Therefore, even in a case in which the motor rotational speed Nf or the output voltage of the battery P is changed, the torque accuracy can be ensured.

As shown in FIG. 7, in a case in which the motor M is controlled by the field weakening control, the current operating point is changed along a magnetic flux restriction circle. In a case in which the motor rotational speed Nf is low or the output voltage of the battery P is low, an actual position of the magnetic flux restriction circle changes as shown by a broken line in FIG. 7. In this case, in a case in which there is only one magnetic flux restriction circle on the control, the torque accuracy cannot be ensured in a case in which the actual magnetic flux restriction circle is changed as shown by a broken line in FIG. 7 in accordance with the motor rotational speed Nf or the state of the output voltage of the battery P. On the other hand, in the electric power converter control device 3 according to the present embodiment, the different magnetic flux restriction circles can be set in the control in accordance with the motor rotational speed Nf or the state of the output voltage of the battery P. Therefore, even in a case in which the motor rotational speed Nf or the output voltage of the battery P is low, the torque accuracy can be ensured.

FIG. 8 is a graph showing a relationship between the motor rotational speed Nf and actual output torque Te of the motor M. As shown in this figure, in a region R1 in which the output torque Te is close to 0 Nm, it is difficult to ensure the torque accuracy in a case of performing control using a single two-dimensional map in which the motor rotational speed and the magnetic flux command value are used as parameters.

As shown in FIG. 8, in a region R2 in which the motor rotational speed Nf is low, the torque command value generator 10 may obtain the torque command value without using the torque feedback value. In such a case, in a case in which the control is performed using a single two-dimensional map having the motor rotational speed and the magnetic flux command value as parameters, it is difficult to ensure the torque accuracy.

In the electric power converter control device 3 according to the present embodiment, even in the region R1 or the region R2 shown in FIG. 8, the different magnetic flux restriction circles can be set in the control in accordance with the motor rotational speed Nf or the state of the output voltage of the battery P Therefore, even in the region R1 or the region R2 shown in FIG. 8, the torque accuracy can be ensured.

In addition, the electric power converter control device 3 according to the present embodiment includes the storage 3a that stores the current command value map Ma. The current command value map Ma is a map showing a relationship between the motor rotational speed Nf, the search direct current voltage value Vdccmp*, and the post-compensation torque command value Tecmp* and the current command value. In addition, the current command value generator 40 obtains the current command values based on the current command value map Ma.

With the electric power converter control device 3 according to the present embodiment, the current command value map Ma is referred to, and thus the current command value can be easily and accurately generated. In addition, with the electric power converter control device 3 according to the present embodiment, it is also possible to use the three-dimensional current command value map Ma in a state in which it is difficult to ensure the torque accuracy as described above, and to use the two-dimensional map using the motor rotational speed and the magnetic flux command value as parameters in other states.

However, even in a case in which the three-dimensional current command value map Ma and the two-dimensional map are used in combination, it is preferable that the current command value is obtained based on the current command value map Ma in a case in which at least the field weakening control is performed. In a case in which the torque command value generator 10 obtains the torque command value without using the torque feedback value, it is preferable that the current command value is obtained based on the current command value map Ma.

In addition, in the electric power converter control device 3 according to the present embodiment, the search direct current voltage value generator 30 obtains the search direct current voltage value Vdccmp* including the direct current voltage correction value (voltage component ΔVh) based on the interlinkage magnetic flux feedback value Φof. Therefore, the electric power converter control device 3 according to the present embodiment can obtain the current command value that reflects the interlinkage magnetic flux feedback value Φof. Therefore, the electric power converter control device 3 according to the present embodiment can further improve the torque accuracy.

In addition, in the electric power converter control device 3 according to the present embodiment, the magnetic flux command value generator 20 calculates the magnetic flux estimation error αε based on the modulation rate coefficient gmref, the post-compensation torque command value Tecmp*, the motor rotational speed Nf, the direct current voltage detection value Vdcf, the current command value, and the minimum armature resistance value Ramin. The magnetic flux command value generator 20 obtains the post-compensation magnetic flux command value Φocmp* by using the magnetic flux estimation error αε. The electric power converter control device 3 according to the present embodiment can obtain the current command value in consideration of the influence of the minimum armature resistance value Ramin. Therefore, the electric power converter control device 3 according to the present embodiment can further improve the torque accuracy.

In addition, the motor control device 1 according to the present embodiment includes the electric power converter 2 and the electric power converter control device 3. Therefore, the motor control device 1 according to the present embodiment can improve the torque accuracy with respect to the post-compensation torque command value Tecmp*.

The preferred embodiments of the present invention have been described above with reference to the accompanying drawings, but it goes without saying that the present invention is not limited to the above-described embodiments. The various shapes, combinations, and the like of the respective components shown in the above-described embodiments are merely examples, and can be variously changed based on design requirements and the like without departing from the gist of the present invention.

It should be noted that the above-described embodiments can also be described as, for example, the following supplementary notes.

### Supplementary Note 1

An electric power converter control device that controls an electric power converter that performs electric power conversion between a direct current electric power supply and a motor, the electric power converter control device including:
a magnetic flux command value generator configured to obtain a magnetic flux command value based on a torque command value and a rotation detection value indicating the rotational speed of the motor;
a direct current voltage value generator configured to obtain a direct current voltage value indicating an output voltage of the direct current electric power supply based on at least a modulation rate coefficient targeted by the electric power converter and the magnetic flux command value; and
a current command value generator configured to obtain a current command value for controlling the motor based on the torque command value, the rotation detection value, and the direct current voltage value.

### Supplementary Note 2

The electric power converter control device according to Supplementary Note 1, further including:
a storage configured to store a current command value map showing a relationship between the rotation detection value, the direct current voltage value, and the torque command value and the current command value,
in which the current command value generator obtains the current command value based on the current command value map.

### Supplementary Note 3

The electric power converter control device according to Supplementary Note 2,
in which, in a case in which at least field weakening control is performed, the current command value is obtained based on the current command value map.

### Supplementary Note 4

The electric power converter control device according to Supplementary Note 2, further including:
a torque command value generator configured to obtain the torque command value by using a torque feedback value calculated based on a state of the motor,
in which, in a case in which the torque command value generator obtains the torque command value without using the torque feedback value, the current command value is obtained based on the current command value map.

### Supplementary Note 5

The electric power converter control device according to any one of Supplementary Notes 1 to 4,
in which the magnetic flux command value generator obtains the magnetic flux command value by using a magnetic flux feedback value calculated based on a state of the motor.

### Supplementary Note 6

The electric power converter control device according to Supplementary Note 5,
in which the direct current voltage value generator obtains the direct current voltage value including a direct current voltage correction value based on the magnetic flux feedback value.

### Supplementary Note 7

The electric power converter control device according to any one of Supplementary Notes 1 to 6,
in which the magnetic flux command value generator calculates a magnetic flux estimation error based on the modulation rate coefficient, the torque command value, the rotation detection value, a detection value of the direct current voltage value, the current command value, and a minimum armature resistance value, and obtains the magnetic flux command value by using the magnetic flux estimation error.

### Supplementary Note 8

An electric power conversion device including: the electric power converter; and
the electric power converter control device according to any one of Supplementary Notes 1 to 7.

### REFERENCE SIGNS LIST

1 Motor control device (electric power conversion device)
2 Electric power converter
3 Electric power converter control device
3a Storage unit
10 Torque command value generator
11 Torque controller
20 Magnetic flux command value generator
30 Search direct current voltage value generator (direct current voltage value generator)
40 Current command value generator
50 Rotational speed calculation portion

1. An electric power converter control device that controls an electric power converter that performs electric power conversion between a direct current electric power supply and a motor, the electric power converter control device comprising:
a magnetic flux command value generator configured to obtain a magnetic flux command value based on a torque command value and a rotation detection value indicating a rotational speed of the motor;
a direct current voltage value generator configured to obtain a direct current voltage value indicating an output voltage of the direct current electric power supply based on at least a modulation rate coefficient targeted by the electric power converter and the magnetic flux command value; and
a current command value generator configured to obtain a current command value for controlling the motor based on the torque command value, the rotation detection value, and the direct current voltage value.

2. The electric power converter control device according to claim 1, further comprising:
a storage configured to store a current command value map showing a relationship between the rotation detection value, the direct current voltage value, and the torque command value and the current command value,
wherein the current command value generator obtains the current command value based on the current command value map.

3. The electric power converter control device according to claim 2,
wherein, in a case in which at least field weakening control is performed, the current command value is obtained based on the current command value map.

4. The electric power converter control device according to claim 2, further comprising:
a torque command value generator configured to obtain the torque command value by using a torque feedback value calculated based on a state of the motor,
wherein, in a case in which the torque command value generator obtains the torque command value without using the torque feedback value, the current command value is obtained based on the current command value map.

5. The electric power converter control device according to claim 1,
wherein the magnetic flux command value generator obtains the magnetic flux command value by using a magnetic flux feedback value calculated based on a state of the motor.

6. The electric power converter control device according to claim 5,
wherein the direct current voltage value generator obtains the direct current voltage value including a direct current voltage correction value based on the magnetic flux feedback value.

7. The electric power converter control device according to claim 1,
wherein the magnetic flux command value generator
calculates a magnetic flux estimation error based on the modulation rate coefficient, the torque command value, the rotation detection value, a detection value of the direct current voltage value, the current command value, and a minimum armature resistance value, and
obtains the magnetic flux command value by using the magnetic flux estimation error.

8. An electric power conversion device comprising:
the electric power converter; and
the electric power converter control device according to any claim 1.
